(19) United States
(12) Patent Application Publication
(10) Pub. No.: US 2020/0277473 A1
(43) Pub. Date: Sep. 3, 2020

(54) Vulcanizable HNBR composition with high thermal conductivity

(71) Applicant: ARLANXEO DEUTSCHLAND GMBH, Köln (DE)

(72) Inventors: Andreas KAISER, Düsseldorf (DE); Susanna LIEBER, Kaiserslautern (DE)

(21) Appl. No.: 16/646,420

(22) PCT Filed: Sep. 18, 2018
(86) PCT No.: PCT/EP2018/075185

§ 371 Date: Mar. 11, 2020

(30) Foreign Application Priority Data
Sep. 20, 2017 (EP) 17192107.5

(51) Int. Cl. C08L 15/00; C08F 236/06; C08K 3/22; C08K 5/00; C08K 3/04; C08K 9/06

(52) U.S. Cl. CPC C08L 15/005; C08F 236/06; C08K 3/22; C08K 2201/006; C08K 3/04; C08K 9/06; C08K 2003/2227; C08K 5/0025

(57) ABSTRACT

The present invention relates to vulcanizable compositions comprising hydrogenated nitrile rubber, synthetic graphite and/or aluminium oxide and a crosslinking agent, to vulcanizates thereof and to the use thereof as component.

The present invention relates to vulcanizable compositions comprising hydrogenated nitrile rubber, synthetic graphite and/or aluminium oxide and a crosslinking agent, to vulcanizates thereof and to the use thereof as component.

Components based on hydrogenated nitrile rubber feature not only high heat and oil resistance but also low thermal conductivity. Typical thermal conductivities of pure rubbers are, for instance, in the range from 0.1 to 0.5 W/m*K. Bayer-Handbuch [Bayer Handbook], 2nd edition 1999, p. 719, discloses values for different vulcanizates of 0.53 W/m*K (vulcanizate based on hydrogenated nitrile rubber) up to 0.95 W/m*K (vulcanizate based on chlorosulfonated polyethylene). A typical HNBR vulcanizate consists, for example, of 30 phr to 100 phr carbon black, 2 phr to 4 phr magnesium oxide, an ageing stabilizer, and a crosslinking system consisting of a coagent (1 phr to 4 phr) and a peroxide (4 phr to 12 phr). Mixtures of this kind after vulcanization have good physical properties, meaning that the materials have elongation at break of up to 600% and tensile strength up to 35 MPa. Thermal conductivity is typically about 0.4 W/m*K.

Thermally conductive vulcanizates are increasingly being used for components having heat removal objectives and to some degree are displacing metallic components. Vulcanizates have the advantage over metallic components that processing by the injection moulding method enables more freedom in shaping and the lower density enables lightweight designs. Various industrial applications, for example electronics, mechatronics or technical parts in the automotive industry, simultaneously require elastic characteristics and a high thermal conductivity of up to 5 W/m*K.

Since the inherent thermal conductivity of rubbers is very low, thermal conductivity is typically increased by means of a filler system or additive system. However, this must not impair the physical properties of the material to too significant a degree.

Examples of known thermally conductive fillers for increasing thermal conductivity in hydrogenated nitrile rubber include metallic fillers (e.g. copper), ceramic fillers (e.g. boron nitride (BN), aluminium oxide (Al₂O₃), aluminium nitride (AlN) and alkaline earth metal oxides, for example magnesium oxide (MgO)), aluminosilicates (SiO₂*Al₂O₃) or organic fillers (graphite, carbon nanotubes (CNTs)).

For instance, CN-A-104945702 discloses HNBR compositions having a thermal conductivity of 4 W/m*K. The fillers that are used to increase thermal conductivity are modified carbon nanotubes, modified graphene and aluminium nitride.

EP-A-2816083 discloses, in Claim 5, components made from a polymer-boron nitride compound comprising hydrogenated nitrile rubber (HNBR) and boron nitride agglomerates as thermally conductive filler, having a thermal conductivity of at least 1.5 W/m*K.

US-A-20140/339780 discloses gaskets made from HNBR and boron nitride nanoparticles, where the gaskets have a thermal conductivity of about 1 W/m*K to about 3 W/m*K.

In order to obtain HNBR vulcanizates having thermal conductivities exceeding 1 W/m*K, large amounts of thermally conductive filler have to be mixed into HNBR. Elevated amounts of boron nitride or carbon nanotubes typically make it difficult to process the rubber composition (for example as a result of a distinct increase in the compound Mooney) and significantly alter the physical properties, since there can, for example, be a drop in elongation at break, tensile strength and tear propagation resistance or a rise in hardness.

A further known thermally conductive filler is also graphite. JP-A-2002-080639 discloses vulcanizates based on HNBR and 60 phr graphite, having a thermal conductivity of 0.36 to 0.6 W/m*K.

As well as conventional graphite, synthetic graphites are also known, for uses including as filler for improving electrical conductivity and for lowering the coefficient of friction of plastics.

US-A-2016/0082774 discloses diene rubber compositions for tyres, comprising, for example, nitrile rubber (NBR) with various thermally conductive fillers, for example exfoliated graphites, CNT, acetylene black, BN, Al₂O₃, LiClO₄, ZnO and metallic particles such as nickel, copper, aluminium or iron, the vulcanizates of which have a thermal conductivity of at least 0.6 W/m*K. There is no description of compositions composed of HNBR and synthetic graphite.

EP-A-2 700 692 discloses hydrogenated nitrile rubber compositions comprising carbon black and/or further fillers. It is also possible to use further additions such as crosslinkers. Claims 1 and 4 disclose organic peroxides as crosslinkers, and graphite and aluminium oxide as fillers.

CN-A-105 440 379 discloses heat-resistant rubber compositions for gaskets. These are based on hydrogenated nitrile rubber, fillers, peroxides and modified graphite. The modified graphite is obtained by treatment with vinyltrimethoxysilane.

CN-A-104 262 724 discloses rubber gaskets made from hydrogenated nitrile rubber, wherein a peroxidic crosslinker and aluminium oxide are processed.

WO-A-16120760 (Timrex C THERM+thermoplastic polymer) discloses compositions containing 20% to 99% by weight of thermoplastic polymer, 0.5% to 50% by weight of expanded graphite platelets having a thickness of more than 1 micrometre, and more than 0% to 60% by weight of further additives. The composition has a thermal conductivity of 1.0 to 30 W/m*K. A filler mentioned for improvement of thermal conductivity is graphite, for example expanded/exfoliated graphite such as TIMREX C-THERM®, which has a higher thermal conductivity than conventional “flake-like” graphites.

What is common to all prior art documents is that there are no known vulcanizable compositions based on HNBR which, after crosslinking, give vulcanizates having high thermal conductivity and satisfactory physical and mechanical properties.

The problem addressed by the present invention was thus that of providing vulcanizable compositions based on HNBR, the vulcanizates of which have a thermal conductivity of 2.0 W/m*K or more, preferably 3.0 W/m*K or more, more preferably 3.5 W/m*K or more and most preferably 4.5 W/m*K or more.

A further problem addressed is that of providing preferably those vulcanizable compositions that have not only a high thermal conductivity but also good processibility, i.e. a Mooney value ML 1+4 of 155 MU or less.

A further problem addressed is that of providing more preferably those vulcanizable compositions that lead to vulcanizates additionally having a Shore A hardness of 100 ShA or less, in order that the material is sufficiently elastic and not too hard.

A further problem addressed is that of providing more preferably those vulcanizable compositions that have no blistering on heating, since blistering worsens the material properties and processing. The problem is particularly manifested in the case of relatively large layer thicknesses >5 mm. In the case of blistering, it is not possible to produce a shaped rubber article with well-defined geometry.

It has been found that, surprisingly, vulcanizable compositions comprising hydrogenated nitrile rubber, synthetic graphite and/or aluminium oxide (Al₂O₃) and crosslinking agents lead to vulcanizates having high thermal conductivities and satisfactory physical and mechanical properties.

The invention provides vulcanizable compositions, characterized in that they comprise
(a) 100 parts by weight of at least one hydrogenated nitrile rubber,
(b) 150 to 300 parts by weight of at least one aluminium oxide and
(c) at least one crosslinking agent, preferably a peroxide compound, an aminic crosslinking agent or a sulfur-containing crosslinking agent.

This solution was surprising in that not every thermally conductive filler known for an increase in thermal conductivity, in the vulcanizable compositions comprising hydrogenated nitrile rubber, leads to vulcanizates having high thermal conductivities of 2.0 W/m*K or more with retention of satisfactory physical and mechanical properties such as hardness, Mooney viscosity and processibility.

Preferred vulcanizable compositions are characterized in that they comprise
(a) 100 parts by weight of hydrogenated nitrile rubber,
(b) more than 20 to 100 parts by weight of at least one synthetic graphite, preferably “TIMREX® C-THERM 001” and
   150 to 300 parts by weight of an aluminium oxide, preferably Martoxid® TM-2410 or Martoxid® TM-1410,
(c) 1 to 20 parts by weight, preferably 2 to 10 parts by weight, of at least one crosslinking agent, preferably a peroxide compound,
(d) 0 to 100 parts by weight, preferably 1 to 80 parts by weight, of one or more customary rubber additives, preferably one or more fillers, especially carbon black, silica, magnesium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the hydrogenated nitrile rubber (a).

Included in the disclosure are vulcanizable compositions, characterized in that they comprise
(a) 100 parts by weight of a hydrogenated nitrile rubber,
(b) 20 to 100 parts by weight of a synthetic graphite having a D₉₀ to DIN 51938 of 70 μm or more, preferably 80 μm or more and more preferably 81 μm, such as “TIMREX® C-THERM 001”,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the hydrogenated nitrile rubber (a).

In an alternative embodiment, particularly preferred vulcanizable compositions are those that are characterized in that they comprise
(a) 100 parts by weight of a hydrogenated nitrile rubber,
(b) 150 to 300 parts by weight, more preferably 150 to 270 parts by weight, of an aluminium oxide,
(c) 1 to 20 parts by weight, preferably 2 to 10 parts by weight, of at least one peroxide compound,
(d) 0 to 100 parts by weight, preferably 1 to 80 parts by weight, of one or more customary rubber additives, preferably one or more fillers, especially carbon black, silica, magnesium oxide, one or more filler-activators, especially based on an organic silane, one or more ageing stabilizers, especially oligomerized 2,2,4-trimethyl-1,2-dihydroquinoline (TMQ), styrenized diphenylamine (DDA), octylated diphenylamine (OCD), cumylated diphenylamine (CDPA) or zinc salt of 4- and 5-methylmercaptobenzimidazole (Vulkanox ZMB2) or 4- and 5-methylmercaptobenzimidazole and/or one or more mould release agents or processing aids, based on 100 parts by weight of the hydrogenated nitrile rubber (a).

Hydrogenated nitrile rubber is used as component (a).

Hydrogenated nitrile rubbers (a) are commercially available, but are also obtainable in all cases by production methods accessible to the person skilled in the art via the literature.

Hydrogenated nitrile rubbers (HNBRs) in the context of this application are understood to mean co- and/or terpolymers containing at least one conjugated diene and at least one α,β-unsaturated nitrile monomer and optionally further copolymerizable monomers, where the copolymerizable diene units have been wholly or partly hydrogenated.

“Hydrogenation” or “hydrogenated” in the context of this application is understood to mean a conversion of the double bonds originally present in the nitrile rubber to an extent of at least 50%, preferably at least 85%, more preferably at least 95%.

The α,β-unsaturated nitrile used may be any known α,β-unsaturated nitrile, preference being given to (C₃-C₅)-α,β-unsaturated nitriles such as acrylonitrile, methacrylonitrile, ethacrylonitrile or mixtures thereof. Acrylonitrile is particularly preferred.

Any conjugated diene can be used. Preference is given to using (C₄-C₆) conjugated dienes. Particular preference is given to 1,3-butadiene, isoprene, 2,3-dimethylbutadiene, piperylene or mixtures thereof. Especially preferred are 1,3-butadiene and isoprene or mixtures thereof. Very particular preference is given to 1,3-butadiene.

The proportions of conjugated diene and α,β-unsaturated nitrile in the hydrogenated nitrile rubbers can be varied within wide ranges. The proportion of, or the sum of, the conjugated dienes is typically in the range from 40% to 90% by weight, preferably in the range from 50% to 80% by weight, based on the overall polymer. The proportion of, or the sum of, the α,β-unsaturated nitriles is typically in the range from 10% to 60% by weight, preferably in the range from 20% to 50% by weight, based on the overall polymer. The additional monomers may be present in amounts in the range from 0.1% to 40% by weight, preferably in the range from 1% to 30% by weight, based on the overall polymer. In this case, corresponding proportions of the conjugated diene(s) and/or of the α,β-unsaturated nitrile(s) are replaced by the proportions of the additional monomers, where the proportions of all monomers in each case add up to 100% by weight.

The preparation of such hydrogenated nitrile rubbers that are suitable for the vulcanizable compositions according to the invention is sufficiently familiar to the person skilled in the art.

The initial preparation of the nitrile rubbers by polymerization of the aforementioned monomers has been described extensively in the literature (e.g. Houben-Weyl, Methoden der Organischen Chemie [Methods of Organic Chemistry], vol. 14/1, Georg Thieme Verlag Stuttgart 1961).

The subsequent hydrogenation of the above-described nitrile rubbers to hydrogenated nitrile rubber can be effected in the manner known to the person skilled in the art.

It is possible in principle to conduct the hydrogenation of nitrile rubbers using homogeneous or heterogeneous hydrogenation catalysts.

As described in WO-A-01/77185, it is possible, for example, to conduct the reaction with hydrogen using homogeneous catalysts, for example that known as the “Wilkinson” catalyst ((PPh₃)₃RhCl) or others. Processes for hydrogenating nitrile rubber are known. Rhodium or titanium are typically used as catalysts, but it is also possible to use platinum, iridium, palladium, rhenium, ruthenium, osmium, cobalt or copper, either as the metal or else preferably in the form of metal compounds (see, for example, U.S. Pat. No. 3,700,637, DE-A-25 39 132, EP-A-134 023, DE-A-35 41 689, DE-A-35 40 918, EP-A-298 386, DE-A-35 29 252, DE-A-34 33 392, U.S. Pat. Nos. 4,464,515 and 4,503,196).

Suitable catalysts and solvents for a hydrogenation in homogeneous phase are described hereinafter and are also known from DE-A-25 39 132 and EP-A-0 471 250.

The selective hydrogenation can be achieved, for example, in the presence of a rhodium catalyst. It is possible to use, for example, a catalyst of the general formula

(R¹ₘB)ₗRhXₙ

in which
R¹ are the same or different and are a C₁-C₈ alkyl group, a C₄-C₈ cycloalkyl group, a C₆-C₁₅ aryl group or a C₇-C₁₅ aralkyl group,
B is phosphorus, arsenic, sulfur or a sulfoxide group S═O,
X is hydrogen or an anion, preferably halogen and more preferably chlorine or bromine,
l is 2, 3 or 4,
m is 2 or 3 and
n is 1, 2 or 3, preferably 1 or 3.

Preferred catalysts are tris(triphenylphosphine)rhodium(I) chloride, tris(triphenylphosphine)rhodium(III) chloride and tris(dimethyl sulfoxide)rhodium(III) chloride, and also tetrakis(triphenylphosphine)rhodium hydride of the formula ((C₆H₅)₃P)₄RhH and the corresponding compounds in which the triphenylphosphine has been replaced fully or partly by tricyclohexylphosphine. The catalyst can be used in small amounts. An amount in the range of 0.01% to 1% by weight, preferably in the range of 0.03% to 0.5% by weight and more preferably in the range of 0.1% to 0.3% by weight, based on the weight of the polymer, is suitable.

It is typically advisable to use the catalyst together with a cocatalyst which is a ligand of the formula R¹ₘB where R¹, m and B are each as defined above for the catalyst. Preferably, m is 3, B is phosphorus and the R¹ radicals may be the same or different. Preference is given to cocatalysts having trialkyl, tricycloalkyl, triaryl, triaralkyl, diarylmonoalkyl, diarylmonocycloalkyl, dialkylmonoaryl, dialkylmonocycloalkyl, dicycloalkylmonoaryl or dicycloalkylmonoaryl radicals.

Examples of cocatalysts can be found, for example, in U.S. Pat. No. 4,631,315. A preferred cocatalyst is triphenylphosphine. The cocatalyst is used preferably in amounts within a range of 0.3% to 5% by weight, more preferably in the range of 0.5% to 4% by weight, based on the weight of the nitrile rubber to be hydrogenated. Preferably, in addition, the weight ratio of the rhodium catalyst to the cocatalyst is in the range from 1:3 to 1:55, more preferably in the range from 1:5 to 1:45. Based on 100 parts by weight of the nitrile rubber to be hydrogenated, in a suitable manner, 0.1 to 33 parts by weight of the cocatalyst, preferably 0.5 to 20 and most preferably 1 to 5 parts by weight, especially more than 2 but less than 5 parts by weight, of the cocatalyst are used, based on 100 parts by weight of the nitrile rubber to be hydrogenated.

The practical performance of such hydrogenations is sufficiently well-known to those skilled in the art, for example from U.S. Pat. No. 6,683,136. It is typically effected by contacting the nitrile rubber to be hydrogenated with hydrogen in a solvent such as toluene or monochlorobenzene at a temperature in the range from 100° C. to 150° C. and a pressure in the range from 50 bar to 150 bar for 2 hours to 10 hours.

In the case of use of heterogeneous catalysts for preparation of hydrogenated nitrile rubbers by hydrogenation of the corresponding nitrile rubbers, the catalysts are typically supported catalysts based on palladium.

The Mooney viscosity (ML 1+4 measured at 100° C.) of the hydrogenated nitrile rubber (a) used or, if still further rubbers are used, of the overall mixture of all rubbers (a) is within a range from 10 to 120, preferably within a range from 20 to 110, more preferably within a range from 30 to 100. The Mooney viscosity is determined here to ASTM Standard D 1646.

The hydrogenated nitrile rubber according to the invention has a residual double bond content (RDB) of 10% or less, preferably of 7% or less, more preferably of 1% or less.

The hydrogenated nitrile rubbers usable in the vulcanizable composition according to the invention have a glass transition temperature of less than −10° C., preferably less than −15° C., more preferably less than −20° C., measured via DSC at a heating rate of 20 K/min.

Examples of commercially available hydrogenated nitrile rubbers are fully and partly hydrogenated nitrile rubbers having acrylonitrile contents in the range of 17% to 50% by weight (Therban® range from ARLANXEO Deutschland GmbH and Zetpol® range from Nippon Zeon Corporation). One example of hydrogenated butadiene/acrylonitrile/acrylate polymers is the Therban® LT series from ARLANXEO Deutschland GmbH, for example Therban® LT 2157 and Therban® LT 2007. One example of carboxylated hydrogenated nitrile rubbers is the Therban® XT series from ARLANXEO Deutschland GmbH. One example of hydrogenated nitrile rubbers having low Mooney viscosities and therefore improved processibility is a product from the Therban® AT series, for example Therban® AT 3404.

The hydrogenated nitrile rubber, as well as repeat units of at least one unsaturated nitrile and at least one conjugated diene, may contain one or more further copolymerizable monomers in the form of carboxylic acids or carboxylic esters.

Suitable copolymerizable carboxylic acids are mono- or dicarboxylic acids which have 3 to 18 carbon atoms and are α,β-unsaturated, and esters thereof. Preferred α,β-unsaturated carboxylic acids are acrylic acid, methacrylic acid, itaconic acid, fumaric acid, maleic acid, crotonic acid and mixtures thereof.

Esters of the α,β-unsaturated carboxylic acids having 3 to 18 carbon atoms preferably include the alkyl esters and the alkoxyalkyl esters of the aforementioned carboxylic acids. Preferred esters of the α,β-unsaturated carboxylic acids having 3 to 18 carbon atoms are methyl acrylate, ethyl acrylate, butyl acrylate, 2-ethylhexyl acrylate, octyl acrylate and polyethylene glycol (meth)acrylate (PEG (meth)acrylate) having 1 to 12 repeat ethylene glycol units. Preferred alkoxyalkyl esters are polyethylene glycol (meth)acrylate (PEG (meth)acrylate) having 1 to 8 repeat ethylene glycol units and butyl acrylates.

Preferred esters of the α,β-ethylenically unsaturated dicarboxylic monoesters are, for example,
alkyl monoesters, especially C₄-C₁₈-alkyl monoesters, preferably n-butyl, tert-butyl, n-pentyl or n-hexyl monoesters, more preferably mono-n-butyl maleate, mono-n-butyl fumarate, mono-n-butyl citraconate, mono-n-butyl itaconate,
alkoxyalkyl monoesters, especially C₁-C₁₈-alkoxyalkyl monoesters, preferably C₄-C₁₂-alkoxyalkyl monoesters,
polyethylene glycol esters (PEG) having 1 to 8 repeat ethylene glycol units,
hydroxyalkyl monoesters, especially C₄-C₁₈-hydroxyalkyl monoesters, preferably C₄-C₁₂-hydroxyalkyl monoesters,
cycloalkyl monoesters, especially C₅-C₁₈-cycloalkyl monoesters, preferably C₆-C₁₂-cycloalkyl monoesters, more preferably monocyclopentyl maleate, monocyclohexyl maleate, monocycloheptyl maleate, monocyclopentyl fumarate, monocyclohexyl fumarate, monocycloheptyl fumarate, monocyclopentyl citraconate, monocyclohexyl citraconate, monocycloheptyl citraconate, monocyclopentyl itaconate, monocyclohexyl itaconate and monocycloheptyl itaconate,
alkylcycloalkyl monoesters, especially C₆-C₁₂-alkylcycloalkyl monoesters, preferably C₇-C₁₀-alkylcycloalkyl monoesters, more preferably monomethylcyclopentyl maleate and monoethylcyclohexyl maleate, monomethylcyclopentyl fumarate and monoethylcyclohexyl fumarate, monomethylcyclopentyl citraconate and monoethylcyclohexyl citraconate; monomethylcyclopentyl itaconate and monoethylcyclohexyl itaconate,
aryl monoesters, especially C₆-C₁₄-aryl monoesters, preferably monoaryl maleate, monoaryl fumarate, monoaryl citraconate or monoaryl itaconate, more preferably monophenyl maleate or monobenzyl maleate, monophenyl fumarate or monobenzyl fumarate, monophenyl citraconate or monobenzyl citraconate, monophenyl itaconate or monobenzyl itaconate or mixtures thereof,
unsaturated polyalkyl polycarboxylates, for example dimethyl maleate, dimethyl fumarate, dimethyl itaconate or diethyl itaconate, or
α,β-ethylenically unsaturated carboxylic esters containing amino groups, for example dimethylaminomethyl acrylate or diethylaminoethyl acrylate.

In a preferred embodiment, the hydrogenated nitrile rubber contains, as well as repeat units of at least one unsaturated nitrile and at least one conjugated diene, additionally alkyl esters of α,β-ethylenically unsaturated carboxylic acids and polyethylene glycol carboxylic esters having 1 to 12 repeat ethylene glycol units.

Component (b) Thermally Conductive Filler

The vulcanizable composition according to the invention comprises, as component (b), at least one thermally conductive filler selected from the group consisting of synthetic graphite or aluminium oxide.

Synthetic graphite is also known as Acheson graphite, which is produced in electrical furnaces by the heating of coke in the presence of silicon. Synthetic graphite is commercially available from suppliers including SGL Carbon, Schunk Kohlenstofftechnik, Imerys and Morgan Advanced Materials.

Synthetic graphites are used in the vulcanizable compositions according to the invention in the form of fibres, rods, spheres, hollow spheres, platelets, in powder form, in each case either in aggregated form or in agglomerated form. In the present invention, the structure in platelet form is understood to mean a particle having a flat geometry. Thus, the height of the particles is typically distinctly smaller compared to the breadth or length of the particles. The length dimensions of the particles can be ascertained by standard methods, for example electron microscopy.

Commercially available synthetic graphites are, for example, TIMREX® KS5-44, TIMREX® KS6, TIMREX® KS150, TIMREX® SFG44, TIMREX® SFG150, TIMREX® C-THERM™ 001 and TIMREX® C-THERM™ 011, C-Therm 012 from Imerys.

Preferred synthetic graphites (b) are those having a D₉₀ according to DIN 51938 of 70 μm or more, preferably 80 μm or more, more preferably 81 μm.

Preferred synthetic graphites (b) have an ash content according to ASTM C_{561/16} of <0.5%, preferably <0.3%.

Preferred synthetic graphites (b) have a density (Scott density measured as bulk density by means of a Scott volumeter) of 0.01 to 1 g/cm³, preferably of 0.1 to 0.2 g/cm³.

A preferred synthetic graphite is TIMREX® C-Therm 001, which is commercially available from Imerys. Synthetic graphites from the C-THERM line have a high aspect ratio. TIMREX® C-Therm 001 has a D₉₀ according to DIN 51938 of 81 μm, an ash content according to ASTM C561-16 of <0.3% and a (bulk) density of 0.15 g/cm³.

If synthetic graphite is used, the compositions according to the invention contain more than 20 to 100 parts by weight, more preferably 40 to 100 parts by weight and most preferably 80 to 120 parts by weight of at least one synthetic graphite (b), based on 100 parts by weight of the hydrogenated nitrile rubbers (a).

In an alternative embodiment, rather than synthetic graphite, aluminium oxide (Al₂O₃) is used in the vulcanizable compositions.

Preferred aluminium oxide is characterized in that it has a purity of >95%, a BET content of 0.8 to 1.6 m²/g (measured to DIN ISO 9277:2003-05) and a tamped density of 1 to 3 g/cm³.

The aluminium oxide used is characterized in that it is coated or uncoated, preferably coated, more preferably coated with alkylsilane.

A particularly preferred alkylsilane-coated aluminium oxide is Martoxid® TM-2410; purity >99%, BET=1.2 m²/g; CAS number: 1344-28-1 (commercially available from Martinswerk (Huber)).

If aluminium oxide is used, the compositions according to the invention contain 150 to 300 parts by weight, more preferably 150 to 270 parts by weight, of at least one aluminium oxide, based on 100 parts by weight of the hydrogenated nitrile rubbers (a).

Component (c) Crosslinking Agent

Examples of useful crosslinking agents include peroxidic crosslinkers, sulfur-containing crosslinkers or aminic crosslinkers, preference being given to peroxidic crosslinkers.

Preferably at least one peroxide compound as crosslinking agent is used as component (c).

Suitable peroxide compounds (c) are, for example, the following peroxide compounds:

bis(2,4-dichlorobenzoyl) peroxide, dibenzoyl peroxide, bis(4-chlorobenzoyl) peroxide, 1,1-bis(tert-butylperoxy)-3,3,5-trimethylcyclohexane, tert-butyl perbenzoate, 2,2-bis(tert-butylperoxy)butene, 4,4-di-tert-butyl peroxynonylvalerate, dicumyl peroxide, 2,5-dimethyl-2,5-di(tert-butylperoxy)hexane, tert-butyl cumyl peroxide, 1,3-bis(tert-butylperoxyisopropyhbenzene, di-tert-butyl peroxide, 2,5-dimethyl-2,5-di(tert-butylperoxy)hexyne, tert-butyl hydroperoxide, hydrogen peroxide, methyl ethyl ketone peroxide, lauroyl peroxide, decanoyl peroxide, 3,5,5-trimethylhexanoyl peroxide, di(2-ethylhexyl) peroxydicarbonate, poly(tert-butyl peroxycarbonate), ethyl 3,3-di(tert-butylperoxy)butyrate, ethyl 3,3-di(tert-amylperoxy)butyrate, n-butyl 4,4-di(tert-butylperoxy)valerate, 2,2-di(tert-butylperoxy)butane, 1,1-di(tert-butylperoxy)cyclohexane, 3,3,5-trimethylcyclohexane, 1,1-di(tert-amylperoxy)cyclohexane, tert-butyl peroxybenzoate, tert-butyl peroxyacetate, tert-butyl peroxy-3,5,5-trimethylhexanoate, tert-butyl peroxyisobutyrate, tert-butyl peroxy-2-ethyl hexanoate, tert-butyl peroxypivalate, tert-amyl peroxypivalate, tert-butyl peroxyneodecanoate, cumyl peroxyneodecanoate, 3-hydroxy-1,1-di methyl butyl peroxyneodecanoate, tert-butyl peroxybenzoate, tert-butyl peroxyacetate, tert-amyl peroxy-3,5,5-trimethylhexanoate, tert-butyl peroxyisobutyrate, tert-butyl peroxy-2-ethylhexanoate, cumyl peroxyneodecanoate, 3-hydroxy-1,1-dimethylbutyl peroxyneodecanoate, 2,5-dimethyl-2,5-di(tert-butylperoxy)hexyne 3-di-tert-amyl peroxide, 2,5-dimethyl-2,5-di(tert-butylperoxy)hexane, tert-amyl hydroperoxide, cumene hydroperoxide, 2,5-dimethyl-2,5-di(hydroperoxy)hexane, diisopropylbenzene monohydroperoxide and potassium peroxodisulfate.

The at least one peroxide compound of the vulcanizable composition according to the invention is preferably an organic peroxide, especially dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, tert-butyl perbenzoate, butyl 4,4-di(tert-butyl peroxy)valerate and/or 1,1-bis(tert-butylperoxy)-3,3,5-trimethylcyclohexane.

Suitable sulfur-containing and aminic crosslinkers are known to those skilled in the art.

Sulfur-containing crosslinkers used may, for example, be sulfur in elemental soluble or insoluble form, or sulfur donors.

Examples of useful sulfur donors include dimorpholyl disulfide (DTDM), 2-morpholinodithiobenzothiazole (MBSS), caprolactam disulfide, dipentamethylenethiuram tetrasulfide (DPTT) and tetramethylthiuram disulfide (TMTD).

In the sulfur vulcanization of the hydrogenated nitrile-diene-carboxylic ester copolymer according to the invention, it is also possible to use further additions which can help to increase the crosslinking yield. In principle, the crosslinking can also be effected with sulfur or sulfur donors alone.

Conversely, however, the crosslinking of the hydrogenated nitrile-diene-carboxylic ester copolymers of the invention may also be effected only in the presence of the abovementioned additions, i.e. without addition of elemental sulfur or sulfur donors.

Suitable additions by means of which the crosslinking yield may be increased include for example dithiocarbamates, thiurams, thiazoles, sulfenamides, xanthogenates, guanidine derivatives, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate. Thiurams used may be, for example: tetramethylthiuram disulfide (TMTD), tetramethylthiuram monosulfide (TMTM), dimethyldiphenylthiuram disulfide, tetrabenzylthiuram disulfide, dipentamethylenethiuram tetrasulfide and tetraethylthiuram disulfide (TETD). Thiazoles used may be, for example: 2-mercaptobenzothiazole (MBT), dibenzothiazyl disulfide (MBTS), zinc mercaptobenzothiazole (ZMBT) and copper 2-mercaptobenzothiazole. Sulfenamide derivatives used may be, for example: N-cyclohexyl-2-benzothiazylsulfenamide (CBS), N-tert-butyl-2-benzothiazylsulfenamide (TBBS), N,N′-dicyclohexyl-2-benzothiazylsulfenamide (DCBS), 2-morpholinothiobenzothiazole (MBS), N-oxydiethylenethiocarbamyl-N-tert-butylsulfenamide and oxyd iethylenethiocarbamyl-N-oxyethylenesulfenamide. Xanthogenates used may be, for example: sodium dibutylxanthogenate, zinc isopropyldibutylxanthogenate and zinc dibutylxanthogenate. Guanidine derivatives used may be, for example: diphenylguanidine (DPG), di-o-tolylguanidine (DOTG) and o-tolylbiguanide (OTBG). Dithiophosphates used may be, for example: zinc dialkyldithiophosphates (chain length of the alkyl radicals C2 to C16), copper dialkyldithiophosphates (chain length of the alkyl radicals C2 to C16) and dithiophosphoryl polysulfide. A caprolactam used may be, for example, dithiobiscaprolactam. Thiourea derivatives used may be, for example, N,N′-diphenylthiourea (DPTU), diethylthiourea (DETU) and ethylenethiourea (ETU).

Likewise suitable as additions are, for example: zinc diaminediisocyanate, hexamethylenetetramine, 1,3-bis(citraconimidomethyl)benzene and cyclic disulfanes.

The recited additions and the crosslinking agents may be used either individually or in mixtures. It is preferable to employ the following substances for the crosslinking of the hydrogenated nitrile-diene-carboxylic ester copolymers: sulfur, 2-mercaptobenzothiazole, tetramethylthiuram disulfide, tetramethylthiuram monosulfide, zinc dibenzyldithiocarbamate, dipentamethylenethiuram tetrasulfide, zinc dialkyldithiophosphate, dimorpholyl disulfide, tellurium diethyldithiocarbamate, nickel dibutyldithiocarbamate, zinc dibutyldithiocarbamate, zinc dimethyldithiocarbamate and dithiobiscaprolactam.

It may be advantageous to use, as well as these crosslinkers, further additions which can help to increase the crosslinking yield: Suitable examples of these include triallyl isocyanurate, triallyl cyanurate, trimethylolpropane tri(meth)acrylate, triallyl trimellitate, ethylene glycol dimethacrylate, butanediol dimethacrylate, zinc diacrylate, zinc dimethacrylate, 1,2-polybutadiene or N,N″-m-phenylenebismaleimide.

The amount of component (c) in the vulcanizable compositions according to the invention is typically 1 to 20 parts by weight, preferably 2 to 10 parts by weight, based on 100 parts by weight of the rubbers (a).

In addition, the vulcanizable composition may comprise further rubber additives (d). Standard rubber additives include, for example: polymers not covered by the inventive definition of component (a), carbon black, further fillers, silica, magnesium oxide, graphene, carbon nanotubes (CNTs), filler-activators, oils, especially processing oils or extender oils, plasticizers, processing auxiliaries, accelerators, multifunctional crosslinkers, ageing stabilizers, antiozonants, antioxidants, mould release agents, retardants, further stabilizers and antioxidants, wollastonite, dyes, fibres comprising organic and inorganic fibres and fibre pulps, vulcanization activators, and additional polymerizable monomers, dimers, trimers or oligomers.

Useful filler-activators include organic silanes in particular, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler-activators are, for example, interface-active substances such as triethanolamine or ethylene glycols with molecular weights of 74 to 10 000 g/mol. The amount of filler-activators is typically 0.5 to 10 parts by weight, based on 100 parts by weight of the hydrogenated nitrile rubbers (a).

Useful ageing stabilizers are especially those which scavenge a minimum number of radicals in the peroxidic vulcanization. These are especially oligomerized 2,2,4-trimethyl-1,2-dihydroquinoline (TMQ), styrenized diphenylamine (DDA), octylated diphenylamine (OCD), cumylated diphenylamine (CDPA), 4- and 5-methylmercaptobenzimidazole (MB2) or zinc salt of 4- and 5-methylmercaptobenzimidazole (ZMB2). In addition, it is also possible to use the known phenolic ageing stabilizers, such as sterically hindered phenols, or ageing stabilizers based on phenylenediamine. It is also possible to use combinations of the ageing stabilizers mentioned, preferably CDPA in combination with ZMB2 or MB2, more preferably CDPA with MB2. Very particular preference is given to pure CDPA.

The ageing stabilizers are typically used in amounts of 0.1 to 5 parts by weight, preferably of 0.3 to 3 parts by weight, based on 100 parts by weight of the hydrogenated nitrile rubbers (a).

Examples of useful mould release agents include: saturated or partly unsaturated fatty acids and oleic acids or derivatives thereof (in the form of fatty acid esters, fatty acid salts, fatty alcohols or fatty acid amides), and also products applicable to the mould surface, for example products based on low molecular weight silicone compounds, products based on fluoropolymers and products based on phenolic resins.

The mould release agents are used as blend component in amounts of 0.2 to 10 parts by weight, preferably 0.5 to 5 parts by weight, based on 100 parts by weight of the hydrogenated nitrile rubbers (a).

Reinforcement of the vulcanizates with glass strengthening elements according to the teaching of U.S. Pat. No. 4,826,721 is also possible, as is reinforcement with aromatic polyamides (aramid).

In a disclosed embodiment, a vulcanizable composition is provided, characterized in that the vulcanizable composition comprises
(a) 100 parts by weight of at least one hydrogenated nitrile rubber,
(b) more than 20 to less than 150 parts by weight of a thermally conductive filler selected from the group consisting of synthetic graphite and aluminium oxide,
(c) 1 to 20 parts by weight, preferably 2 to 10 parts by weight, of at least one peroxide compound,
(d) 0 to 100 parts by weight, preferably 1 to 80 parts by weight, of one or more customary rubber additives.

A particularly preferred embodiment is vulcanizable compositions comprising
(a) 100 parts by weight of at least one hydrogenated nitrile rubber,
(b) 40 to 100 parts by weight of a synthetic graphite, or 150 to 270 parts by weight of aluminium oxide, and
(c) 2 to 10 parts by weight of at least one peroxide compound.

Also disclosed are vulcanizable compositions comprising
(a) 100 parts by weight of hydrogenated nitrile rubber,
(b) 80 to 120 parts by weight of a synthetic graphite,
(c) 2 to 10 parts by weight of at least one peroxide compound.

The invention further provides a process for producing the aforementioned vulcanizable compositions according to the invention, by mixing all components (a), (b) and (c) and optionally (d). This can be effected using apparatuses and mixing units known to those skilled in the art.

The sequence in which the components are mixed with one another is not of fundamental importance, but is matched in each case to the mixing units available and the temperature regime.

The mixing of components (a), (b) and (c) and optionally (d) can be effected here, according to temperature, using the typical mixing systems that are in common use in the rubber industry. It is possible to use i) batchwise mixing units in the form of mixing rolls or internal mixers and ii) continuous mixing units such as mixing extruders.

It has been found to be particularly useful to conduct the mixing of components (a), (b) and (c) and optionally (d) at a defined mixer temperature in the range from about 30 to 40° C., since sufficiently high shear forces can be applied here with the abovementioned mixing units that are in common use in the rubber processing industry to achieve good mixing.

Preferably, the hydrogenated nitrile rubber (a) is initially charged and masticated, and then all further components apart from the vulcanization chemicals (peroxide compound and coagent) are added. After an appropriate mixing time, the mixture is discharged.

The peroxide compound and the coagent are mixed in in a second step on a roll. The speed of the roll is controlled here such that stable skins are obtained.

In practice, after the components according to the invention have been mixed, the vulcanizable compositions are obtained, for example, in the form of what are called “skins”, feed strips or feed slabs, or else in the form of pellets or granules. These can subsequently be pressed in moulds or injection-moulded and are crosslinked under suitable conditions according to the free-radical donors used.

The invention further provides for the production of vulcanizates by subjecting the aforementioned vulcanizable compositions to an input of energy, especially a thermal treatment.

The input of energy can be effected, for example, in the form of thermal energy. The production of the vulcanized products by means of thermal treatment is conducted by subjecting the vulcanizable compositions according to the invention to a temperature in the range from preferably 120 to 200° C., more preferably from 140 to 180° C., in a customary manner in suitable moulds. The vulcanization can be brought about with the aid of any method, such as compression vulcanization, steam vulcanization and the like.

In the course of crosslinking of the vulcanizable composition according to the invention, the peroxide compounds (c) lead to free-radical crosslinking between and with the hydrogenated nitrile rubbers (a) used.

The invention also further provides vulcanizates, i.e. crosslinked rubbers, obtainable via crosslinking (vulcanization) of the aforementioned vulcanizable compositions by input of energy, especially by thermal treatment.

The invention also further provides components comprising a vulcanizate produced from a vulcanizable composition according to the invention.

These components are preferably gaskets, belts and hoses.

The vulcanizates obtained by the vulcanizing of the vulcanizable composition can be processed by a customary method to give a belt, a gasket, a hose or the like, and these products are particularly excellent products having the above-described properties. More particularly, such vulcanizates have a high thermal conductivity of 2.0 W/m*K or more.

The invention thus further provides for the use of 40 to 120 parts by weight of synthetic graphite, preferably TRIMEX C-Therm™ 001, based on 100 parts by weight of the hydrogenated nitrile rubbers (a), in a vulcanizable composition comprising at least one hydrogenated nitrile rubber (a) and at least one peroxide compound (c) for increasing the thermal conductivity of vulcanizates to 2.0 W/m*K or more and with retention of a Mooney viscosity of less than 155 MU.

The basic production of such gaskets and hoses is known to those skilled in the art. For the production of belts, the person skilled in the art can proceed using the vulcanizable compositions according to the invention, for example, analogously to the disclosure of U.S. Pat. No. 4,715,607.

### EXAMPLES

Production, Vulcanization and Characterization of the Compositions

Examples C to H are inventive examples. Examples A* and B* and I* to K* which follow are non-inventive comparative examples. The comparative examples are identified in the tables which follow by an * after the example number.

The primary mixing unit used was an internal mixer of the GK 1.5 E type (manufacturer: HF Mixing Group). The speed was 40 min⁻¹, the cooling water inlet temperature 40° C. This involved masticating the initial charge of the hydrogenated nitrile rubber (a) for 1 minute, then adding all further components apart from the vulcanization chemicals (peroxide compound and coagent). 3 minutes after commencement of mixing, the plunger was pulled out and brushed. After a mixing time of 250 seconds, the mixture was discharged.

The peroxide compound and the coagent were mixed in in a second step at about 30° C. on a roll (manufacturer: Tröster, roll diameter 20 cm). The friction was 1:1.11. The speed of the roll was controlled here such that stable skins were obtained. Subsequently, vulcanization of these skins was undertaken in slab presses at 180° C. for 15 min.

Components Used:

| | |
|---|---|
| Therban ® 3627 | partly hydrogenated nitrile rubber, ACN content: 36% by |
| | weight, Mooney viscosity ML 1 + 4 @100° C.: 66 MU, |
| | residual double bond content: max. 2%, available from |
| | ARLANXEO |
| Therban ® 3407 | hydrogenated nitrile rubber, ACN content: 34% by |
| | weight, Mooney viscosity ML 1 + 4 @100° C.: 70 MU, |
| | residual double bond content: max. 0.9%, available from |
| | ARLANXEO |
| Therban ® 3443 VP | partly hydrogenated nitrile rubber, ACN content: 34% by |
| | weight, Mooney viscosity ML 1 + 4 @100° C.: 39 MU, |
| | residual double bond content: max. 4%, available from |
| | ARLANXEO |
| Therban ® 3668 VP | partly hydrogenated nitrile rubber, ACN content: 36% by |
| | weight, Mooney viscosity ML 1 + 4 @100° C.: 80 MU, |
| | residual double bond content: max. 6%; available from |
| | ARLANXEO |
| Therban ® XT VP KA 8889 | hydrogenated carboxylated nitrile rubber (terpolymer), |
| | ACN content: 33% by weight, Mooney viscosity ML 1 + 4 |
| | @100° C.: 77 MU, residual double bond content: 3.5%; |
| | available from ARLANXEO |
| Corax ® N 550 | ASTM carbon black; available from Orion Engineered |
| | Carbon |
| Corax ® N 220 | ASTM carbon black; available from Orion Engineered |
| | Carbon |
| Corax ® N 990 | MT carbon black; available from Orion Engineered |
| | Carbon |
| Vulkasil ® A1 | sodium aluminium silicate, available from Rheinchemie |
| | Rheinau GmbH |
| Silatherm ® 1360-8 | aluminosilicate, available from HPF Quarzwerke GmbH |
| CFA 50 boron nitride | boron nitride, available from 3M Deutschland GmbH |
| TIMREX ® C-Therm 001 | synthetic graphite; D₉₀ = 81 μm (to DIN 51938), |
| | ash <0.3% (to ASTM C561-16), available from Imerys, |
| | CAS-Nummer: 7782-42-5 |
| Martoxid ® TM-2410 | alkylsilane-coated surface-coated aluminium oxide; |
| | purity >99%, BET = 1.2 m²/g, tamped density = |
| | 1.8 g/cm³; available from Martinswerk (Huber), CAS |
| | number: 1344-28-1 |
| Martoxid ® TM-1410 | uncoated aluminium oxide; purity >99%, BET = |
| | 1.2 m²/g, tamped density = 1.8 g/cm³; vailable from |
| | Martinswerk (Huber), CAS number: 1344-28-1 |
| Silquest ® RC-1 Silane | organic silanizing agent, available from Momentive |
| | Performance Materials, Inc., |
| Dynasylan ® 6490 | oligomeric siloxane, available from Evonik Industries |
| Dymalink ® 633 | zinc diacrylate, available from Cray Valley |
| Mistron ® R10 C | talc, available from Imerys |
| Maglite ® DE | magnesium oxide, available from CP Hall |
| Vulkanox ® HS | 2,2,4-trimethyl-1,2-dihydroquinoline, polymerized, |
| | available from Lanxess Deutschland GmbH |
| Luvomaxx ® CDPA | 4,4′-bis(1,1-dimethylbenzyl)diphenylamine, available |
| | from Lehmann and Voss |
| Vulkanox ® MB2 | 4- and 5-methyl-2-mercaptobenzimidazole; available |
| | from Lanxess Deutschland GmbH |
| Aflux ®18 | primary fatty amine, available from Rheinchemie |
| | Rheinau GmbH |
| Rhenofit TRIM/S | 70% trimethylolpropane trimethacrylate on 30% silica; |
| | coagent; available from Rhein Chemie Rheinau GmbH |
| Perkadox ® 14-40 | di(tert-butylperoxyisopropyl)benzene 40% supported on |
| | silica, available from Akzo Nobel Polymer Chemicals BV |

The amounts in part by weight stated in the examples are based on 100 parts by weight of the hydrogenated nitrile rubber (a).

Mooney viscosity is measured according to DIN 53523/3 or ASTM D 1646 at 100° C. for the HNBR-containing mixtures.

Shore A hardness was measured in accordance with ASTM-D2240-81.

Elongation at break and tensile strength of the vulcanizates are measured on S2 specimens according to DIN 53504 at room temperature.

Thermal conductivity is measured by means of a stationary method. This involves holding a 2 mm-thick test specimen at room temperature in contact with a heat source and a temperature sensor until an equilibrium of the heat flow in the test specimen has been established. The measurement is then effected by means of a DTC 300 instrument from TA instruments. Thermal conductivity is then calculated from the calibration factor, the specimen thickness and the temperature drop above

TABLE 1
Vulcanizable compositions (examples with
a * are non-inventive comparative tests)

| | C* | D* | E* | F* | G | H |
|---|---|---|---|---|---|---|
| Examples | [pts. by wt.] | | | | | |
| Therban ® AT 3443 VP | 100 | 100 | 100 | 100 | 100 | 100 |
| Corax ® N 550 | 5 | 5 | 5 | 5 | | 5 |
| Corax ® N 220 | | | | | 30 | |
| TIMREX ® C-Therm 001 | 40 | 80 | 120 | 150 | | |
| Martoxid ® TM-2410 | | | | | 150 | 270 |
| Dynasylan ® 6490 | 1 | 1 | 1 | | | |
| Maglite ® DE | 3 | 3 | 3 | 3 | 3 | 3 |
| Vulkanox ® HS | 1.1 | 1.1 | 1.1 | 1.1 | 1.1 | 1.1 |
| Vulkanox ® MB2 | 0.3 | 0.3 | 0.3 | 0.3 | 0.3 | 0.3 |
| Aflux ®18 | 1 | 1 | 1 | 1 | 1 | 1 |
| Rhenofit ® TRIM/S | 2 | 2 | 2 | 2 | 2 | 2 |
| Perkadox ® 14-40 | 5 | 5 | 5 | 5 | 5 | 5 |

| PROPERTIES | | C* | D* | E* | F* | G | H |
|---|---|---|---|---|---|---|---|
| ML 1 + 4 | MU | 69.3 | 117.1 | 151.4 | n.d. | 58.6 | 97.7 |
| Hardness | [ShA] | 77 | 87 | 92 | 93 | 60 | 72 |
| Elongation | [%] | 423 | 100 | 36 | 23 | 536 | 528 |
| at break | | | | | | | |
| Tensile | [MPa] | 9 | 10.1 | 16 | 15.7 | 12 | 8.6 |
| strength | | | | | | | |
| Thermal | [W/m*K] | 2.06 | 3.68 | 4.44 | 3.84 | 2.0 | 3.32 |
| conductivity | | | | | | | |
| Blistering on | | y | y | y | y | n | n |
| heating | | | | | | | |

MU = Mooney units;
n = no;
y = yes;
n.d. = not determined (>155.0 MU)

The tests show that the vulcanizates C to C and G to H have a high thermal conductivity of 2.00 to 4.44 W/m*K.

Vulcanizates C*, D*, E* and F* comprising only synthetic graphite (Timrex® C-THERM 001) as thermally conductive filler, have blistering. Vulcanizates comprising aluminium oxide (Martoxide® TM-2410), by contrast, do not have any blistering and are thus preferred.

The Mooney viscosity (ML 1+4) of the vulcanizable composition increases as the amount of Timrex® C-THERM 001 increases. Vulcanizable compositions comprising aluminium oxide, by contrast, have a lower Mooney viscosity than vulcanizable compositions having the same amount of Timrex® C-THERM 001. A lower Mooney viscosity results in better processibility of the vulcanizable compositions. Compositions having 150 parts by weight of Timrex® C-THERM 001 have an excessively high Mooney viscosity.

Elongation at break decreases as the amount of Timrex C-THERM 001 increases. Vulcanizates having high amounts of aluminium oxide, by contrast, have high and hence preferred elongation at break.

TABLE 2
Vulcanizable compositions (comparison)

| | A* | B* | I* | J* | K* |
|---|---|---|---|---|---|
| Examples | [pts. by wt.] | | | | |
| Therban ® 3443 VP | 100 | 100 | | | |
| Therban ® 3407 | | | 100 | | |
| Therban ® 3627 | | | | 100 | 100 |
| Corax ® N 550 | 5 | 5 | | 15 | 15 |
| Corax ® N 990 | | | 65 | | |
| Vulkasil ® A1 | | | 5 | | 5 |
| TIMREX ® C-Therm 001 | | 20 | | | |
| Mistron ® R10 C | | | 15 | | |
| CFA 50 boron nitride | | | | 80 | |
| Silatherm ® 1360-8 | | | | | 80 |
| Silquest ® RC-1 Silane | | | 0.5 | 1 | 1 |
| Dymalink ®633 | | | 8 | | |
| Maglite ® DE | 3 | 3 | 4 | 3 | 3 |
| Vulkanox ® HS | 1.1 | 1.1 | | | |
| Luvomaxx ® CDPA | | | 1.5 | 1.5 | 1.5 |
| Vulkanox ® MB2 | 0.3 | 0.3 | 0.3 | 0.3 | 0.3 |
| Aflux ® 18 | 1 | 1 | | | |
| Rhenofit ® TRIM/S | 2 | 2 | 2.5 | 2 | 2 |
| Perkadox ® 14-40 | 5 | 5 | 8 | 8 | 8 |

| PROPERTIES | | A* | B* | I* | J* | K* |
|---|---|---|---|---|---|---|
| ML 1 + 4 | MU | 39.1 | 55.5 | n.d. | n.d. | n.d. |
| Hardness | [ShA] | 47 | 65 | 78 | 82 | 69 |
| Elongation | [%] | 557 | 541 | 197 | 305 | 265 |
| at break | | | | | | |
| Tensile | [MPa] | 24.3 | 15.3 | 18.3 | 14 | 13.5 |
| strength | | | | | | |
| Thermal | [W/m*K] | 0.88 | 1.6 | 0.5 | 1.25 | 0.49 |
| conductivity | | | | | | |
| Blistering on | | n | y | y | y | n |
| heating | | | | | | |

MU = Mooney units;
n = no;
y = yes;
n.d. = not determined (>155 MU)

The vulcanizable compositions from Examples A* and B* and I* to K* serve as a comparative test for inventive examples, since these contain no aluminium oxide (Martoxid® TM-2410).

The comparative examples show that vulcanizates A* and B* and I* to K* have a low thermal conductivity of only 0.44 to 1.6 W/m*K.

The example series also shows that the inventive vulcanizates C to E and G to H have better processibility than comparative examples A* and B* and I* to K*.

TABLE 3
Vulcanizable compositions

| | L | M | N | O | P |
|---|---|---|---|---|---|
| Examples | [pts. by wt. | | | | |
| Therban ® 3443 VP | 100 | 70 | 100 | 100 | 100 |
| Therban ® XT VP KA 8889 | | 30 | | | |
| Corax ® N 220 | 20 | 20 | 20 | 20 | 20 |
| TIMREX ® C-Therm 001 | 60 | 60 | 60 | 60 | 60 |
| Martoxid ® TM-2410 | 200 | 200 | | | |
| Martoxid ® TM-1410 | | | 200 | 200 | 200 |
| Silquest ® RC-1 Silane | | | | 5 | |
| Vulkasil ® N | | | | | 20 |
| Maglite ® DE | 3 | | 3 | 3 | 3 |
| Aflux ® 18 | 1 | 1 | 1 | 1 | 1 |
| Rhenofit ® TRIM/S | 2 | 2 | 2 | 2 | 2 |
| Perkadox ® 14-40 | 9 | 9 | 9 | 9 | 9 |

| PROPERTIES | | L | M | N | O | P |
|---|---|---|---|---|---|---|
| ML 1 + 4 | MU | 120.68 | 117.12 | 137.64 | 115.7 | 139.51 |
| Hardness | [ShA] | 94 | 94 | 93 | 94 | 95 |
| Elongation | [%] | 72 | 59 | 51 | 40 | 51 |
| at break | | | | | | |
| Tensile | [MPa] | 15.4 | 15.5 | 13.9 | 19 | 13.8 |
| strength | | | | | | |
| Thermal | [W/m*K] | 5.0 | 4.8 | 5.3 | 4.7 | 5.3 |
| conductivity | | | | | | |

MU = Mooney units

The examples L, M, N, O and P comprise 100 parts by weight hydrogenated nirtrile rubber (Therban® 3443 VP; Therban® XT VP KA 8889), 60 party by weight synthetic graphite (TIMREX® C-Therm 001) and 200 parts by weight aluminium oxide (Martoxid® TM-2410; Martoxid® TM-1410).

The examples show, that all the inventive vulcanizates L to P have a high thermal conductivity of more than 4.5 W/m*K.

In-situ silanisation (example O) lead to an improved tensile strength.

The example N comprising non-functionalized aluminum oxide (Martoxid® TM-1410) has a slightly improved thermal conductivity compared to example L with functionalized aluminium oxide (Martoxid® TM-2410).

1. A vulcanizable composition comprising:
(a) 100 parts by weight of at least one hydrogenated nitrile rubber,
(b) 150 to 300 parts by weight of at least one aluminium oxide and
(c) at least one crosslinking agent.

2. The vulcanizable composition according to claim 1, which further comprises:
20 to 100 parts by weight of at least one synthetic graphite.

3. The vulcanizable composition according to claim 1, wherein the at least one hydrogenated nitrile rubber is (a) a co- or terpolymer containing at least one conjugated diene and at least one α,β-unsaturated nitrile monomer and optionally further copolymerizable monomers, in which the copolymerized diene units have been wholly or partly hydrogenated.

4. The vulcanizable composition according to according to claim 2, wherein the synthetic graphite (b) has a D₉₀ according to DIN 51938 of 70 μm or more, preferably 80 μm or more and more preferably 81 μm.

5. The vulcanizable composition according to claim 2, wherein the synthetic graphite (b) has an ash content to ASTM C561-16 of <0.5%, preferably <0.3%.

6. The vulcanizable composition according to claim 2, wherein the synthetic graphite (b) has a density (Scott density measured as bulk density by means of a Scott volumeter) of 0.01 to 1 g/cm³.

7. The vulcanizable composition according to claim 2, wherein the synthetic graphite (b) has a D₉₀ to DIN 51938 of 81 μm, an ash content to ASTM C561-16 of <0.3% and a (bulk) density of 0.15 g/cm³.

8. The vulcanizable composition according to claim 1, wherein the aluminium oxide (b) is coated or uncoated and has a purity of >95%, a BET content of 0.8 to 1.6 m²/g (measured to DIN ISO 9277:2003-05) and a tamped density of 1 to 3 g/cm³.

9. The vulcanizable composition according to claim 1, wherein the aluminium oxide (b) is coated.

10. The vulcanizable composition according to claim 15, wherein the at least one crosslinking agent (c) is an organic peroxide selected from: dicumyl peroxide, t-butyl cumyl peroxide, bis(t-butylperoxyisopropyl)benzene, di-t-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoyl) peroxide, t-butyl perbenzoate, butyl 4,4-di(t-butylperoxy)valerate and 1,1-bis(t-butylperoxy)-3,3,5-trimethylcyclohexane.

11. The vulcanizable composition according to claim 1, wherein the amount of crosslinking agent (c) is 1 to 20 parts by weight, based on 100 parts by weight of the rubbers (a).

12. The vulcanizable composition of claim 2, which comprises:
(c) 1 to 20 parts by weight, of at least one crosslinking agent,
(d) 0 to 100 parts by weight, of one or more rubber additives, based on 100 parts by weight of the hydrogenated nitrile rubber (a).

13. A vulcanizate formed by the input of energy to a vulcanizable composition of claim 1.

14. A vulcanizate according to claim 13.

15. The vulcanizable composition of claim 1, wherein the crosslinking agent is selected from: a peroxide compound, an aminic crosslinking agent or a sulfur-containing crosslinking agent.

16. The vulcanizable composition of claim 9, wherein the aluminum oxide is coated with an alkylsilane.

17. The vulcanizable composition of claim 12, which comprises 1 to 80 parts by weight of one or more rubber additives.

18. The vulcanizable composition of claim 12, wherein the rubber additives are selected from preferably one or more fillers, one or more filler-activators, one or more ageing stabilizers, and/or one or more mould release agents or processing aids.

19. The vulcanizate according to claim 14, selected from: gaskets, belts and hoses.
